(19) United States
(12) Patent Application Publication
(10) Pub. No.: US 2006/0076703 A1
(43) Pub. Date: Apr. 13, 2006

(54) Double flow channel for an extruder head

(76) Inventors: Ernest Wilford Looman JR., Tallmadge, OH (US); Bruce Joseph Turner, Wadsworth, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 10/964,010

(22) Filed: Oct. 13, 2004

(51) Int. Cl. B29C 47/00

(52) U.S. Cl. 264/167; 264/176.1; 425/464; 425/380

(57) ABSTRACT

The invention provides a method and apparatus for forming simultaneously two or more elastomeric strips of predetermined cross-sectional profiles from a material. The material is received from an extruder into an inlet channel where it is divided into a first and a second angled flow passage. The material passes through a transition area where it is straightened out and the center of mass of the material is moved into alignment with the center of a divertor located in a downstream discharge channel. The material is then discharged into a preformer and die.

### TECHNICAL FIELD

This invention relates to an apparatus for directing the flow of elastomeric material through an extruder head.

### BACKGROUND OF THE INVENTION

In the art of extruding strips of material such as plastic or elastomeric, the use of an extruder having a heated barrel and a screw that provides shear energy to the material to be plasticized is well known. As the material is heated, it generally converts from a solid pellet or strip form into a strip of plasticized material at the end of the screw tip that projects the material into an extruder head. This extruder head generally has a single flow channel having a straight flow path that directs the plasticized material through the extruder head to an outlet or discharge die that forms the material into the proper predetermined cross-sectional profile.

It is common practice in the rubber industry to use a single flow channel to extrude tire treads. The utilization of multiple cavity extrusion has been achieved for component extrusions such as sidewalls, wedges, chafers, fillers and apexes. However, the use of multiple extrusions for treads has been more elusive, since it has been very difficult to make a uniform, precise extrudate required in today's tire treads. The dividing of the rubber flow into two angled channels has the disadvantage of causing a mass and velocity imbalance across the die. In the preparation of tire treads for example, this effect can have a detrimental effect on the product quality of the resultant tire since the accuracy with which the tread can be applied to the unvulcanized tire is reduced and an asymmetry in the molded tire, called conicity, can be created. For this reason, most manufacturers have chosen to utilize a single cavity tread extrusion system.

### SUMMARY OF THE INVENTION

The invention provides in a first aspect an extruder head for forming simultaneously two or more elastomeric strips of predetermined cross-sectional profiles from a material, the extruder head comprising: an inlet for receiving the material; a first and a second flow passage communicating with the flow inlet, each flow passage having a transition section with flat sidewalls and a centerline. The transition area centerline is offset from a divertor centered within a discharge channel connected to the transition area.

The invention provides in a second aspect a method of forming simultaneously two or more elastomeric strips of predetermined cross-sectional profiles from a material, the method comprising the steps of: receiving the material from an extruder into a channel; dividing the material from the channel into a first and a second angled flow passage, straightening out the flow in a transition area of the first and second flow passages; and moving the center of mass of the material into alignment with the center of a divertor located in a discharge channel, and discharging the material from each discharge channel into a die.

### BRIEF DESCRIPTION OF THE DRAWINGS

FIG. 1 is a top plan view of the extruder flow channel connected to an extruder on the upstream side of the material flow and to a profiling die on the downstream side of the channel flow, and

FIG. 2 is a cross-section taken from FIG. 1 along lines 2-2.

### DETAILED DESCRIPTION OF THE INVENTION

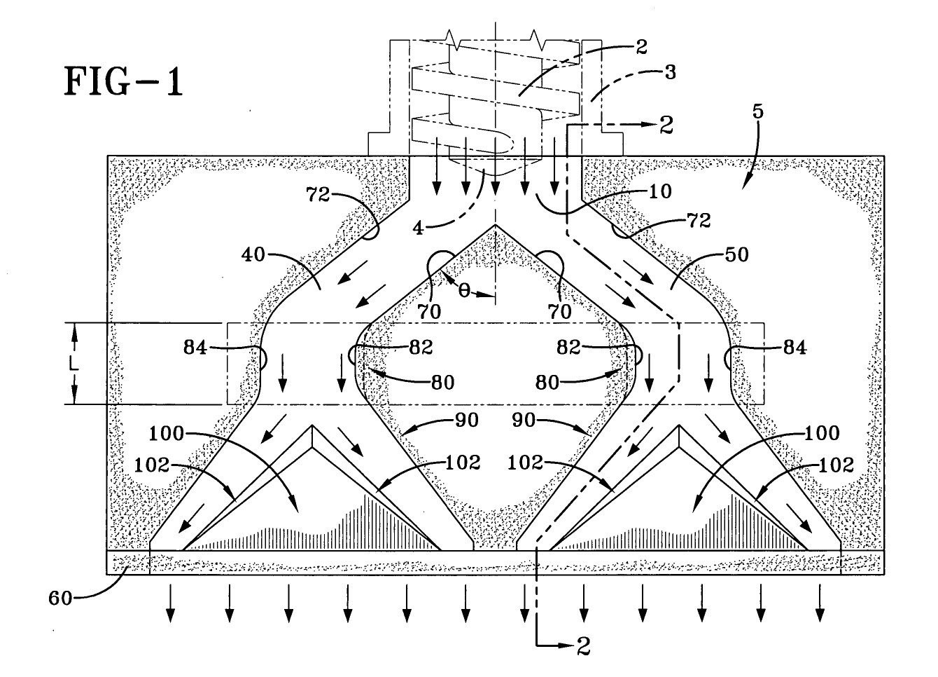

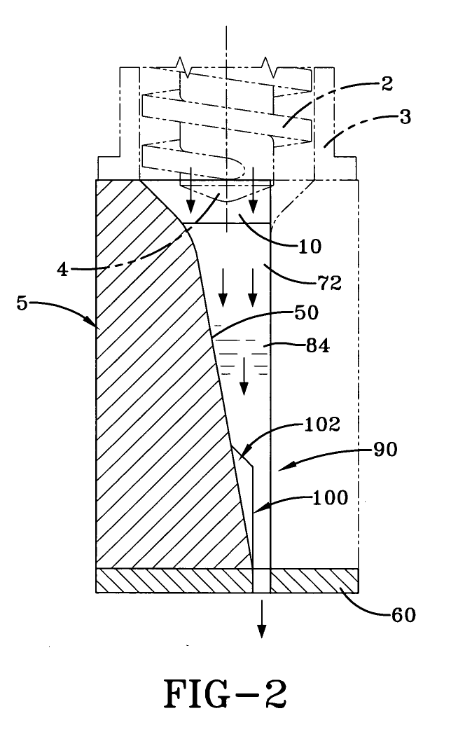

With reference to FIGS. 1 and 2, an extruder (partially shown) has an extruder screw 2 with an extruder screw tip 4 enclosed in an extruder barrel 3. Attached to the extruder barrel is an extruder head 5. The extruder head has a flow channel 10 for receiving plastic or elastomeric material such as rubber. The flow channel 10 is further divided downstream into two flow channels 40,50 for preforming the flow. Each channel 40,50 has an outlet end for discharging the plasticized material through a die for forming the profile of the elastomeric strip to be produced. This die is commonly referred to as a profile die 60.

After the material flows from the extruder barrel 3 and enters the inlet of the flow channel 10, the mass flow is divided into two flow channels 40,50. The flow channels are oriented at an angle Ø in the range of about 30-60 degrees, and preferably about 50 degrees. As the material flows down the angled flow channels 40,50, the material travels faster along the inner walls 70 than along the outside walls 72. Further, more of the mass of the material is concentrated along the inner wall 70. Thus the angled flow channel results in an uneven mass and velocity distribution, with a faster flowing mass more concentrated along the inner wall.

To counteract this flow imbalance, a transition section 80 is added prior to the flow discharge section 90. The transition section 80 comprises inner and outer flat sidewalls 82,84 wherein the sidewalls entering and exiting the transition area are curved. The transition section 80 has a length L and a width W. Preferably the width about equals the length, and has a sufficient length L sized to stabilize the flow into a uniform mass profile. Thus the flow in the transition area is parallel to the inlet flow and the discharge flow.

Since a disproportionate amount of mass of the material entering the transition area is near the inner wall 82, the transition area 80 functions to shift the mass towards the outer wall 84, so that the center of mass of the flow is centered in alignment with the downstream flow divertor. The transition section 80 has a centerline which is slightly offset towards the outer wall from the centerline of the flow discharge channel. The effect of the offset transition centerline is to shift the mass of the flow towards the outer wall, and thus into a more uniform distribution. The amount of centerline transition offset may depend upon the flow characteristics of the particular material selected. Typically for rubber, the offset may be in the range of 1 to about 6 mm.

After the flow exits the transition area, it enters the flow discharge channel 90. Centered with each flow discharge channel is a flow divertor 100, which is preferably shaped like a wing, having sweeping leading edges 102. Each flow divertor is preferably symmetrical in design about its centerline. The flow divertor 100 functions to spread out the material into the desired width prior to flowing into the die 60.

What is claimed is:

1. An extruder head for forming simultaneously two or more elastomeric strips of predetermined cross-sectional profiles from a material, the extruder head comprising:
an inlet for receiving the material;
a first and a second flow channel communicating with the flow inlet end and each channel having a transition section, each transition section having flat sidewalls and a centerline;
a first and second discharge channel in fluid communication with the first and second flow passage; each discharge channel having a divertor centered therein; wherein the transition area centerline is offset from the centerline of the divertor.

2. A method of forming simultaneously two or more elastomeric strips of predetermined cross-sectional profiles from a material, the method comprising the steps of:
receiving the material from an extruder into a channel;
dividing the material from the channel into a first and a second angled flow channel,
straightening out the flow in a transition area of the first and second flow channel; and
moving the center of mass of the material into alignment with the center of a divertor located in a discharge channel, and discharging the material from each discharge channel into a die.

3. An extruder head for forming simultaneously two or more elastomeric strips of predetermined cross-sectional profiles from a material, the extruder head comprising:
an inlet for receiving the material;
a first and a second flow channel communicating with the flow inlet end and each channel having a transition section,
a first and second discharge channel in fluid communication with the first and second flow channel; wherein the transition area flow, the discharge flow and the inlet flow are about parallel.
